(19) United States
(12) Patent Application Publication
(10) Pub. No.: US 2018/0052804 A1
(43) Pub. Date: Feb. 22, 2018

(54) LEARNING MODEL GENERATION SYSTEM, METHOD, AND PROGRAM

(71) Applicant: NEC CORPORATION, Tokyo (JP)

(72) Inventors: Sawako MIKAMI, Tokyo (JP); Keisuke UMEZU, Tokyo (JP); Yousuke MOTOHASHI, Tokyo (JP)

(73) Assignee: NEC CORPORATION, Tokyo (JP)

(21) Appl. No.: 15/560,622

(22) PCT Filed: Mar. 26, 2015
(86) PCT No.: PCT/JP2015/001741

§ 371 Date: Sep. 22, 2017

(51) Int. Cl. G06F 15/18; G06Q 10/06; G06Q 10/04; G06N 7/00; G06F 17/18

(52) U.S. Cl. CPC G06F 15/18; G06Q 10/063; G06F 17/18; G06N 7/005; G06Q 10/04

(57) ABSTRACT

Provided is a learning model generation system capable of preventing a decrease in prediction accuracy in a case where the trend of an actual value of a prediction target has changed. The learning model generation means 71 generates a learning model using, as learning data, time series data in which a value of each explanatory variable used in prediction of a prediction target is associated with an actual value of the prediction target. The prediction means 72 calculates a predicted value of the prediction target using the learning model once the value of each explanatory variable is given. The change point determination means 73 determines a change point which is a point in time when a trend of the actual value of the prediction target changed. The data correction means 74 corrects the time series data by adding a difference between the actual value and the predicted value of the prediction target at the change point and afterward to the actual value before the change point in the time series data when the change point is determined. The learning model generation means 71 regenerates the learning model using the time series data after the correction as the learning data once the time series data is corrected.

### TECHNICAL FIELD

The present invention relates to a learning model generation system, a learning model generation method, and a learning model generation program configured to generate a learning model.

### BACKGROUND ART

Various techniques for predicting the number of store visitors to a certain place and the like have been proposed (refer to, for example, Patent Literatures 1 and 2).

Patent Literature 1 describes a method of calculating the prospective number of attendees to an event on the basis of a visit pattern. In the method described in Patent Literature 1, visit patterns are corrected according to entrance record information on an event during the exhibition period and record information on an event of similar kind held in the past to re-calculate visit prediction data for the event during the exhibition period.

A prediction system described in Patent Literature 2 creates a probability table of a Bayesian network from empirical data. Then, the prediction system described in Patent Literature 2 outputs number-of-visitors prediction data on the basis of this probability table and information received from an external information input unit (information used as a parameter when the number of visitors is predicted).

### CITATION LIST

### Patent Literature

PTL 1: Japanese Patent Application Laid-Open No. 2007-265317

PTL 1: Japanese Patent Application Laid-Open No. 2005-228014

### SUMMARY OF INVENTION

### Technical Problem

There is a general technique for generating a learning model to be used in prediction of a prediction target by machine learning. Here, a variable representing data used as a parameter at the time of prediction is called “explanatory variable”, while a variable representing a prediction target is called “objective variable”.

Even if a predicted value obtained by applying the value of each explanatory variable to a learning model continues to have almost a similar value to an actual value, the trend of the actual value sometimes changes at a certain point in time and afterward. For example, in some cases, the actual value becomes larger than the actual value until a certain point in time at the certain point in time and afterward, or conversely, the actual value becomes smaller than the actual value until a certain point in time at the certain point in time and afterward. Consequently, a difference between the predicted value and the actual value increases because the trend of the actual value has changed.

A specific example will be described below. For example, it is supposed that a learning model for predicting the number of store visitors per day in a convenience store is generated. In addition, it is assumed that a situation where a predicted value of the number of store visitors per day obtained by applying the value of each explanatory variable to this learning model has a similar value to an actual value (the actual number of store visitors) has continued. After that, it is assumed that, as a stadium opened in the vicinity of the convenience store, the actual value of the number of store visitors increased at the opening day of the stadium and afterward as compared with the actual value before the opening day of the stadium and the trend of the actual value has changed. In such a case, a difference between the predicted value of the number of store visitors obtained from the above learning model and the actual value increases. This means that the accuracy of the learning model decreases at a certain point in time (in this example, the day when the stadium opened) and afterward.

As described above, there is a case where the accuracy of the predicted value decreases at a certain point in time and afterward due to a sudden change in the situation.

However, the techniques described in Patent Literatures 1 and 2 do not take into consideration a change in the trend of the actual value caused by a sudden change in the situation. Therefore, in a case where the trend of the actual value has changed due to a sudden change in the situation, the techniques described in Patent Literatures 1 and 2 cannot prevent the prediction accuracy from decreasing.

Therefore, an object of the present invention is to provide a learning model generation system, a learning model generation method, and a learning model generation program capable of solving a technical problem for preventing a decrease in prediction accuracy in a case where the trend of the actual value of a prediction target has changed.

### Solution to Problem

A learning model generation system according to the present invention is characterized by including a learning model generation means that generates a learning model for calculating a predicted value of a prediction target using, as learning data, time series data in which a value of each explanatory variable used in prediction of the prediction target is associated with an actual value of the prediction target; a prediction means that calculates the predicted value of the prediction target using the learning model once the value of each explanatory variable is given; a change point determination means that determines a change point which is a point in time when a trend of the actual value of the prediction target changed; and a data correction means that corrects the time series data by adding a difference between the actual value and the predicted value of the prediction target at the change point and afterward to the actual value before the change point in the time series data when the change point is determined, in which the learning model generation means regenerates the learning model using the time series data after the correction as the learning data once the time series data is corrected.

In addition, a learning model generation method according to the present invention is characterized by generating a learning model for calculating a predicted value of a prediction target using, as learning data, time series data in which a value of each explanatory variable used in prediction of the prediction target is associated with an actual value of the prediction target; calculating the predicted value of the prediction target using the learning model once the value of each explanatory variable is given; determining a change point which is a point in time when a trend of the actual value of the prediction target changed; correcting the time series data by adding a difference between the actual value and the predicted value of the prediction target at the change point and afterward to the actual value before the change point in the time series data when the change point is determined; and regenerating the learning model using the time series data after the correction as the learning data in a case where the time series data is corrected.

Furthermore, a learning model generation program according to the present invention is characterized by causing a computer to execute learning model generation processing of generating a learning model for calculating a predicted value of a prediction target using, as learning data, time series data in which a value of each explanatory variable used in prediction of the prediction target is associated with an actual value of the prediction target; prediction processing of calculating the predicted value of the prediction target using the learning model once the value of each explanatory variable is given; change point determination processing of determining a change point which is a point in time when a trend of the actual value of the prediction target changed; data correction processing of correcting the time series data by adding a difference between the actual value and the predicted value of the prediction target at the change point and afterward to the actual value before the change point in the time series data when the change point is determined; and processing of regenerating the learning model using the time series data after the correction as the learning data in a case where the time series data is corrected.

### Advantageous Effects of Invention

According to the technical means of the present invention, it is possible to prevent a decrease in prediction accuracy in a case where the trend of the actual value of the prediction target has changed.

### BRIEF DESCRIPTION OF DRAWINGS

FIG. 1 It depicts a block diagram illustrating an example of a learning model generation system of the present invention.

FIG. 2 It depicts a schematic diagram illustrating an example of time series data stored in a data storage unit.

FIG. 3 It depicts a graph illustrating a change in trend of actual values.

FIG. 4 It depicts a graph illustrating a change in trend of actual values.

FIG. 5 It depicts a schematic diagram illustrating a result obtained by adding a difference to an actual value before a change point in a case where the actual value becomes a larger value than those until the change point at the change point and later.

FIG. 6 It depicts a schematic diagram illustrating a result obtained by adding a difference to an actual value before a change point in a case where the actual value becomes a smaller value than those until the change point at the change point and afterward.

FIG. 7 It depicts a flowchart illustrating processing progress of generating a learning model by a learning model generation unit and calculating a predicted value by a prediction unit.

FIG. 8 It depicts a flowchart illustrating an example of processing progress of specifying a change point and regenerating a learning model.

FIG. 9 It depicts an explanatory diagram illustrating an example of determining a change point without using a predicted value.

FIG. 10 It depicts an explanatory diagram illustrating an example of determining a change point without using a predicted value.

FIG. 11 It depicts an overview block diagram illustrating a configuration example of a computer according to an exemplary embodiment of the present invention.

FIG. 12 It depicts a block diagram illustrating the outline of the learning model generation system of the present invention.

### DESCRIPTION OF EMBODIMENTS

Hereinafter, exemplary embodiments of the present invention will be described with reference to the drawings.

In the following exemplary embodiments, a case where the number of store visitors per day in a convenience store is treated as a prediction target will be described as an example, but the prediction target is not limited to this example.

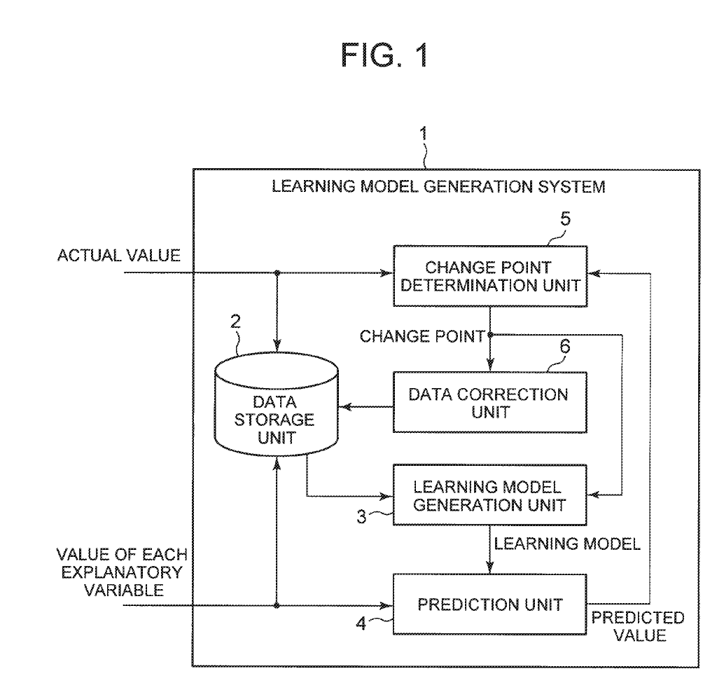

FIG. 1 is a block diagram illustrating an example of a learning model generation system of the present invention. The learning model generation system 1 of the present invention includes a data storage unit 2, a learning model generation unit 3, a prediction unit 4, a change point determination unit 5, and a data correction unit 6.

The data storage unit 2 is a storage device that stores time series data in which the value of each explanatory variable used in prediction of the prediction target (the number of store visitors per day in a convenience store; hereinafter, simply referred to as the number of store visitors) is associated with an actual value of this prediction target. The explanatory variable is a variable representing data used as a parameter at the time of prediction. Here, description is made assuming that plural types of explanatory variables are used.

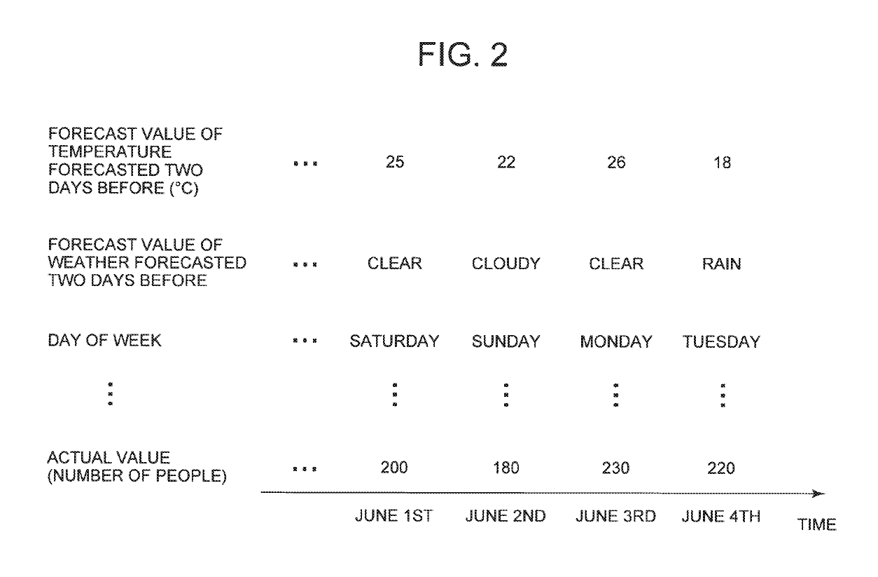

FIG. 2 is a schematic diagram illustrating an example of the time series data stored in the data storage unit 2. A horizontal axis illustrated in FIG. 2 represents time. In the present exemplary embodiment, a case where “one day” is treated as a unit of time will be described as an example. As illustrated in FIG. 2, in the time series data, the actual value and the value of each explanatory variable are associated with each other at each time (on a daily basis). Data obtained by organizing a set of the actual value and the value of each explanatory variable in time order is stored in the data storage unit 2 as the time series data.

The value of each explanatory variable corresponding to a certain time (date) is used as a parameter when a predicted value of the prediction target at that time is calculated.

The actual value illustrated in FIG. 2 is the number of customers who actually visited the convenience store on each day. In addition, in the example illustrated in FIG. 2, the explanatory variables are exemplified as “forecast value of temperature forecasted two days before prediction target day”, “forecast value of weather forecasted two days before prediction target day”, and “day of the week of prediction target day”. These explanatory variables are exemplary and the explanatory variables are not limited to the above examples.

When the value of each explanatory variable for predicting the number of store visitors on the prediction target day and the actual value of the number of store visitors on the same prediction target day are newly input, this value of each explanatory variable and this actual value are associated with each other and added to the time series data stored in the data storage unit 2. In the present exemplary embodiment, it is assumed that every day is individually treated as the prediction target day.

The learning model generation unit 3 generates a learning model using the time series data exemplified in FIG. 2 as learning data by machine learning. The learning model generation unit 3 can set data from the time series data equivalent to a period set in advance as the learning data. This period is referred to as a learning data period. In this example, a case where the learning data period is two years will be described as an example, but the learning data period is not limited to two years.

For example, when the learning model is generated for the first time, it is only required to prepare time series data equivalent to two years in advance such that the learning model generation unit 3 generates a learning model using this time series data equivalent to two years as learning data.

A method by which the learning model generation unit 3 generates the learning model is not particularly limited. For example, the learning model generation unit 3 may generate a learning model by regression analysis using learning data. Alternatively, the learning model generation unit 3 may generate a learning model by another machine learning algorithm.

The learning model may be, for example, a prediction formula for calculating the value of an objective variable. For simplicity of explanation, a case where the learning model is a prediction formula expressed by following formula (1) will be described as an example. However, the form of the learning model is not limited to the form of the prediction formula.

y=a₁x₁+a₂x₂+ . . . +aₙxₙ+b Formula (1)

y is an objective variable representing the predicted value. x₁ to xₙ are explanatory variables. a₁ to aₙ are coefficients of the explanatory variables. b is a constant term. The values of a₁ to aₙ and b are fixed by the learning model generation unit 3 on the basis of the learning data.

The value of each explanatory variable used in prediction of the number of store visitors on the prediction target day is input to the prediction unit 4 from, for example, an administrator of the learning model generation system 1 (hereinafter, simply referred to as administrator) for each time (in this example, on a daily basis). The prediction unit 4 calculates a predicted value y of the number of store visitors on the prediction target day by applying the value of each input explanatory variable to the learning model. As in this example, when the learning model is expressed by the prediction formula illustrated in formula (1), the prediction unit 4 substitutes values into x₁ to xₙ in the prediction formula in accordance with the value of each input explanatory variable, thereby calculating the predicted value y. Hereinafter, an operation of the prediction unit 4 substituting values into x₁ to xₙ in the prediction formula in accordance with the values of the explanatory variables will be described.

There are continuous variables and categorical variables as types of the explanatory variables.

The continuous variable takes a numerical value as a value. For example, the forecast value of the temperature illustrated in FIG. 2 is a continuous variable.

The categorical variable takes an item as a value. For example, the forecast value of the weather and the day of the week illustrated in FIG. 2 are categorical variables.

One continuous variable corresponds to one of the explanatory variables x₁ to xₙ in the prediction formula. The prediction unit 4 substitutes the value (numerical value) of an explanatory variable falling within the continuous variable into a corresponding explanatory variable in the prediction formula.

Meanwhile, each value of one categorical variable corresponds to one of the explanatory variables x₁ to xₙ in the prediction formula. For example, each possible value of “day of the week” (each item such as “Sunday” or “Monday”), which is a categorical variable, corresponds to one of the explanatory variables x₁ to xₙ in the prediction formula. The prediction unit 4 substitutes one of binary values (assumed as 0 and 1 in this example) into each explanatory variable in the prediction formula corresponding to each value of the categorical variables. For example, when the value of input “day of the week” is “Monday”, the prediction unit 4 substitutes 1 into an explanatory variable in the prediction formula corresponding to Monday and substitutes 0 into each explanatory variable in the prediction formula corresponding to each day of the week except Monday.

As described above, the prediction unit 4 calculates the predicted value y of the number of store visitors by substituting values into x₁ to xₙ in the prediction formula in accordance with the values of the explanatory variables.

The prediction unit 4 sends the predicted value of the number of store visitors that has been calculated to the change point determination unit 5.

In addition, the values of each explanatory variable input for each day are added to the time series data stored in the data storage unit 2. For example, when the value of each explanatory variable is input in order to calculate the predicted value for a certain prediction target day, the prediction unit 4 simply stores this value of each explanatory variable to the data storage unit 2. A case where the prediction unit 4 stores the value of each input explanatory variable to the data storage unit 2 has been exemplified here, a means for storing the value of each input explanatory variable to the data storage unit 2 may be separately provided.

A point in time when the trend of the actual value of the prediction target changed will be referred to as a change point. The change point determination unit 5 determines a change point.

The actual value of the number of store visitors per day is input to the change point determination unit 5 from, for example, the administrator for each time (in this example, on a daily basis).

Note that the actual value input for each day is added to the time series data stored in the data storage unit 2 in association with the value of each explanatory variable used for calculating the predicted value with the day on which the actual value was obtained as the prediction target day. The processing of adding the input actual value to the time series data stored in the data storage unit 2 in association with the value of each explanatory variable as described above may be performed by, for example, the change point determination unit 5. Alternatively, a means for executing the processing of adding the input actual value to the time series data may be separately provided.

As modes of a change in trend of the actual value, there are a mode in which the actual value becomes a larger value than those until the change point at the change point and later and a mode in which the actual value becomes a smaller value than those until the change point at the change point and later.

The determination of the change point in a case where the actual value becomes a larger value than those until the change point at the change point and later will be described. The change point determination unit 5 compares the predicted value and the actual value of the number of store visitors for each prediction target day (that is, on a daily basis) and, in a case where the actual value continues to be larger than the predicted value by a threshold value or more for a predetermined period consecutively, determines a first point in time when the actual value became larger than the predicted value by the threshold value or more as the change point. This predetermined period is referred to as a determination period. The determination period is set in advance. Hereinafter, a case where the determination period is three days will be described as an example, but the determination period is not limited to three days and may be, for example, one week or the like. The threshold value is also set in advance.

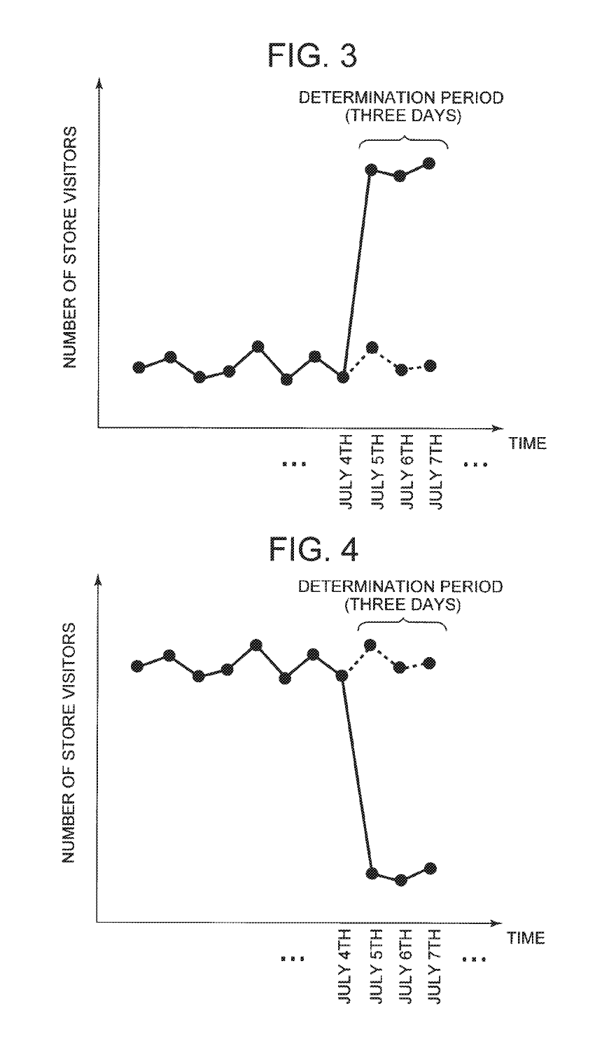

FIG. 3 is a graph illustrating a change in trend of the actual values. The graph illustrated in FIG. 3 exemplifies a case where the actual value becomes a larger value than those until a certain point in time at the certain point in time and later. A horizontal axis illustrated in FIG. 3 represents time and a vertical axis represents the number of store visitors. In addition, in FIG. 3, solid lines indicate a change in the actual value for the store visitors and broken lines indicate a change in the predicted value for the store visitors. In the example illustrated in FIG. 3, it is assumed that the actual value and the predicted value for the store visitors have similar values up to “July 4th”. Note that, in order to simplify the graph, the graph is illustrated in FIG. 3 on the assumption that the actual value and the predicted value coincide up to “July 4th”.

It is assumed that the actual value continues to be larger than the predicted value by the threshold value or more for three consecutive days from July 5th (refer to FIG. 3). Then, the change point determination unit 5 determines July 5th, which is a first point in time when the actual value became larger than the predicted value by the threshold value or more, as the change point. Therefore, after July 7th comes, the change point determination unit 5 determines that July 5th is the change point.

Next, the determination of the change point in a case where the actual value becomes a smaller value than those until the change point at the change point and later will be described. The change point determination unit 5 compares the predicted value and the actual value of the number of store visitors for each prediction target day (that is, on a daily basis) and, in a case where the actual value continues to be smaller than the predicted value by a threshold value or more for the determination period consecutively, determines a first point in time when the actual value became smaller than the predicted value by the threshold value or more as the change point.

FIG. 4 is a graph illustrating a change in trend of the actual values. The graph illustrated in FIG. 4 exemplifies a case where the actual value becomes a smaller value than those until a certain point in time at the certain point in time and later. As in the graph illustrated in FIG. 3, a horizontal axis represents time and a vertical axis represents the number of store visitors. In addition, solid lines indicate a change in the actual value for the store visitors and broken lines indicate a change in the predicted value for the store visitors. Also in the example illustrated in FIG. 4, it is assumed that the actual value and the predicted value for the store visitors have similar values up to “July 4th”. Note that, in order to simplify the graph, the graph is illustrated also in FIG. 4 on the assumption that the actual value and the predicted value coincide up to “July 4th”.

It is assumed that the actual value continues to be smaller than the predicted value by the threshold value or more for three consecutive days from July 5th (refer to FIG. 4). Then, the change point determination unit 5 determines July 5th, which is a first point in time when the actual value became smaller than the predicted value by the threshold value or more, as the change point. Therefore, after July 7th comes, the change point determination unit 5 determines that July 5th is the change point, as in the case exemplified in FIG. 3.

The change point determination unit 5 sends information on the determined change point to the data correction unit 6 and the learning model generation unit 3.

The data correction unit 6 calculates a difference between the actual value and the predicted value of the prediction target at the change point and afterward. For example, the data correction unit 6 subtracts the predicted value from the actual value to find out a difference between both for each day in a period from the change point to a point in time when the change point was determined (in other words, the determination period starting from the change point) and then calculates an average value of these differences.

In a case where the actual value becomes a larger value than those until the change point at the change point and later (refer to FIG. 3), each of the above-mentioned differences has a positive value and the average value of the differences also has a positive value. In a case where the actual value becomes a smaller value than those until the change point at the change point and later (refer to FIG. 4), each of the above-mentioned differences has a negative value and the average value of the differences also has a negative value.

The data correction unit 6 adds the average value of the differences calculated as described above (hereinafter, simply referred to as difference) to the actual value before the change point in the time series data, thereby correcting the time series data stored in the data storage unit 2.

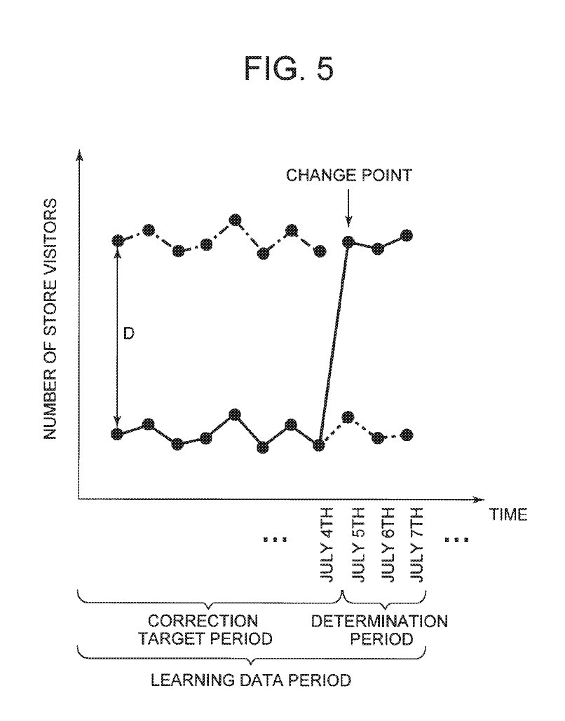

FIG. 5 is a schematic diagram illustrating a result obtained by adding the difference to the actual value before the change point in a case where the actual value becomes a larger value than those until the change point at the change point and later. In FIG. 5, the value of the difference is assumed as D. In this case, as described above, the difference has a positive value. That is, in the example illustrated in FIG. 5, D>0 is established. As described with reference to FIG. 3, the change point is assumed as July 5th. The data correction unit 6 adds the difference D to the actual value before the change point (July 5th). As a result, as illustrated in FIG. 5, the trend of the actual values before the change point and the trend of the actual values at the change point and afterward become comparable to each other. Therefore, if the learning model generation unit 3 regenerates the learning model using, as the learning data, the time series data including the actual value corrected by adding the difference D as described above, a learning model capable of calculating the predicted value of the number of store visitors at the change point and afterward with high accuracy can be obtained.

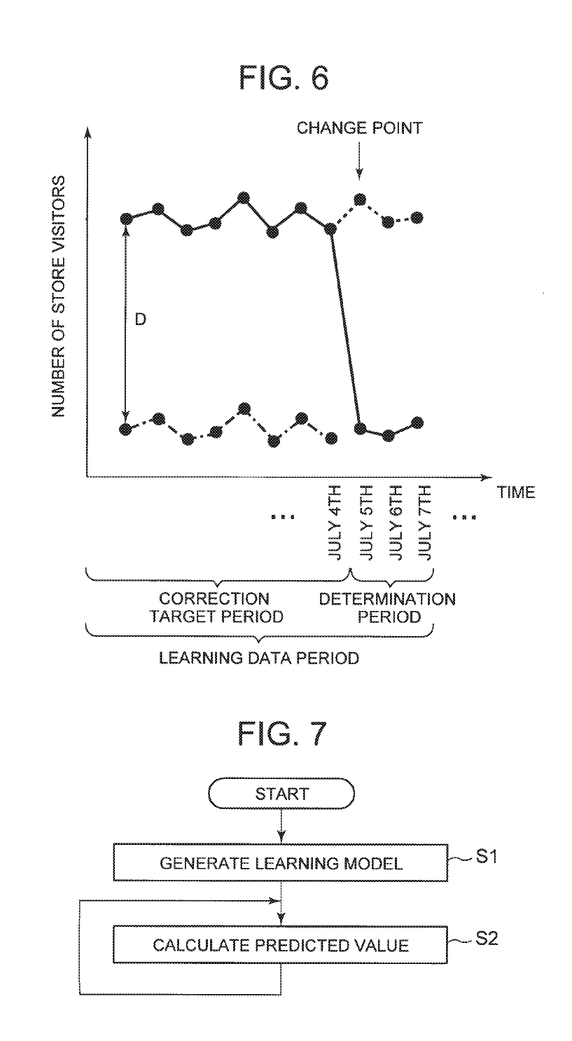

FIG. 6 is a schematic diagram illustrating a result obtained by adding the difference to the actual value before the change point in a case where the actual value becomes a smaller value than those until the change point at the change point and afterward. Also in FIG. 6, the value of the difference is assumed as D. In this case, as described above, the difference has a negative value. That is, in the example illustrated in FIG. 6, D<0 is established. As described with reference to FIG. 4, the change point is assumed as July 5th. The data correction unit 6 adds the difference D to the actual value before the change point (July 5th). As a result, as illustrated in FIG. 6, the trend of the actual values before the change point and the trend of the actual values at the change point and afterward become comparable to each other. Therefore, if the learning model generation unit 3 regenerates the learning model using, as the learning data, the time series data including the actual value corrected by adding the difference D as described above, a learning model capable of calculating the predicted value of the number of store visitors at the change point and afterward with high accuracy can be obtained.

Next, a period for which the data correction unit 6 adds the difference D to the actual value is assumed as a predetermined period before the change point (July 5th). This predetermined period is different from the above-described determination period. In order to distinguish this predetermined period from the determination period, this predetermined period is referred to as a correction target period. The length of the correction target period is set in advance such that a period obtained by adding the determination period (three days in this example) to the correction target period serves as the learning data period (two years in this example). Therefore, the length of a period obtained by subtracting the determination period from the learning data period can be set in advance as the length of the correction target period.

When correcting the actual value in the time series data stored in the data storage unit 2, the data correction unit 6 corrects the actual value by adding the difference D to the actual value of each point in time within the correction target period before the change point (July 5th) (in other words, the actual values of July 4th, which is a point in time directly before the change point, and earlier). The difference D is an average value of differences obtained by subtracting the predicted value from the actual value for each point in time (each day) within the determination period starting from the change point.

Note that the data correction unit 6 does not correct the value of each explanatory variable included in the time series data.

Once the data correction unit 6 corrects the actual value in the time series data as described above, the learning model generation unit 3 uses the time series data for the earliest point in time and afterward within the correction target period before the change point as learning data to regenerate the learning model. More specifically, the learning model generation unit 3 regenerates the learning model using the time series data equivalent to the learning data period starting from the earliest point in time within the correction target period as learning data. In the example illustrated in FIG. 5 or 6, the learning model generation unit 3 regenerates the learning model using the time series data from the earliest date within the correction target period to July 7th as learning data. As illustrated in FIG. 5 or 6, this learning data also includes data for the determination period starting from the change point (data in which the actual value and the value of each explanatory variable are associated with each other). No correction has been made for the actual value within the determination period starting from the change point.

Note that the learning model generation unit 3 can specify the earliest point in time within the correction target period before the change point on the basis of the change point sent from the change point determination unit 5.

The learning model generation unit 3, the prediction unit 4, the change point determination unit 5, and the data correction unit 6 are realized by, for example, a CPU of a computer operating in line with a learning model generation program. In this case, the CPU reads the learning model generation program from a program recording medium such as a program storage device (illustration is omitted in FIG. 1) of this computer and, in line with this learning model generation program, operates as the learning model generation unit 3, the prediction unit 4, the change point determination unit 5, and the data correction unit 6. Alternatively, the learning model generation unit 3, the prediction unit 4, the change point determination unit 5, and the data correction unit 6 may be separately realized by different pieces of hardware.

In addition, the learning model generation system 1 may have a configuration in which two or more physically separated devices are connected by wired or wireless connection.

Next, processing progress will be described. FIG. 7 is a flowchart illustrating processing progress of generating a learning model by the learning model generation unit 3 and calculating the predicted value by the prediction unit 4.

The learning model generation unit 3 generates a learning model using, as learning data, the time series data equivalent to the learning data period, in which the actual value and the value of each explanatory variable are associated with each other (step S1). As described above, the method of generating the learning model using the learning data is not particularly limited. In addition, in this example, it is assumed that the learning model generation unit 3 generates the learning model in the form of the prediction formula. The learning model generation unit 3 sends the generated learning model to the prediction unit 4.

Once the value of each explanatory variable is input, the prediction unit 4 substitutes this value of each explanatory variable into the learning model (prediction formula) to calculate the predicted value (step S2). Since this operation has already been described, a description thereof will be omitted here. In step S2, the prediction unit 4 sends the predicted value that has been calculated to the change point determination unit 5. Every time the value of the explanatory variable of each day is input, the prediction unit 4 repeats calculation of the predicted value (step S2).

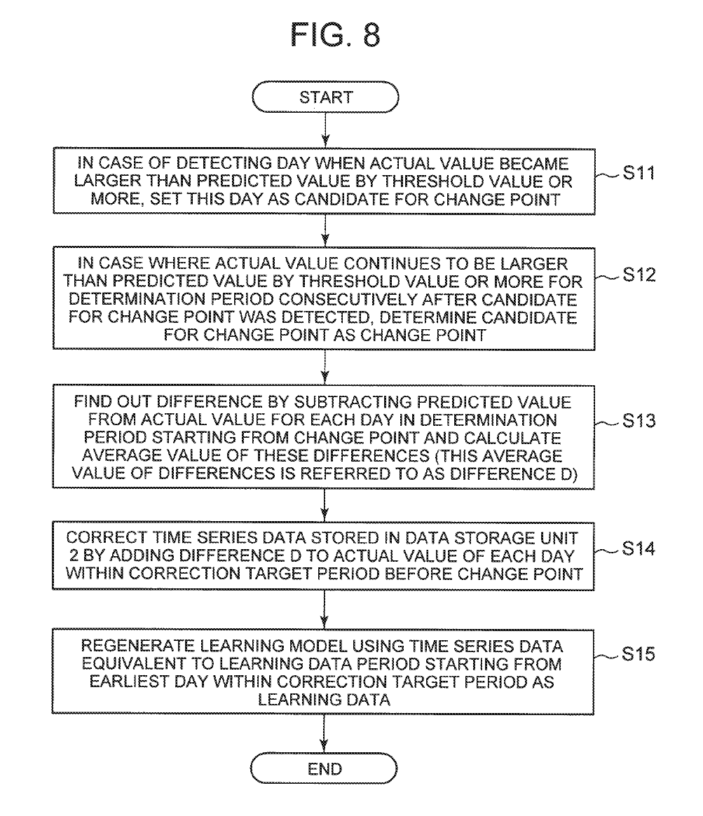

FIG. 8 is a flowchart illustrating an example of processing progress of specifying the change point and regenerating the learning model.

The change point determination unit 5 compares the actual value of the number of store visitors input from the outside for each day with the predicted value sent from the prediction unit 4 and, in the case of detecting the day when the actual value became larger than the predicted value by the threshold value or more, sets this day as a candidate for the change point (step S11).

In a case where the actual value continues to be larger than the predicted value by the threshold value or more for the determination period consecutively after the candidate for the change point was detected in step S11, the change point determination unit 5 determines the candidate for the change point as the change point (step S12). That is, the candidate for the change point is settled as the change point in step S12. The change point determination unit 5 sends information on the change point to the data correction unit 6 and the learning model generation unit 3.

Note that, in a case where the actual value does not continue to be larger than the predicted value by the threshold value or more for the determination period consecutively after the candidate for the change point was detected in step S11, the change point determination unit 5 cancels the candidate for the change point detected in step S11 from candidate. Then, the change point determination unit 5 waits until the change point determination unit 5 detects a candidate for the change point again.

After step S12, the data correction unit 6 finds out the difference by subtracting the predicted value from the actual value for each day in the determination period starting from the change point and then calculates the average value of these differences (step S13). This average value of the differences is referred to as the difference D.

Then, the data correction unit 6 corrects the time series data stored in the data storage unit 2 by adding the difference D to the actual value of each day within the correction target period before the change point (step S14).

After step S14, the learning model generation unit 3 regenerates the learning model using the time series data equivalent to the learning data period starting from the earliest day within the correction target period as learning data (step S15). The method of generating the learning model in step S15 is the same as the method of generating the learning model in step S1 (refer to FIG. 7).

Once the learning model generation unit 3 regenerates the learning model in step S15, the learning model generation unit 3 sends this learning model to the prediction unit 4. Every time the value of the explanatory variable of each day is input to the prediction unit 4, the prediction unit 4 repeats calculation of the predicted value (step S2). At this time, once the learning model generated in step S15 is sent, the prediction unit 4 thereafter calculates the predicted value using this learning model.

In the flowchart illustrated in FIG. 8, a case where the actual value becomes a larger value than those until the change point at the change point and later has been described as an example. The actual value may become a smaller value than those until the change point at the change point and later. In that case, when the change point determination unit 5 detects, in step S11, the day when the actual value became smaller than the predicted value by the threshold value or more, the change point determination unit 5 simply sets that day as a candidate for the change point. Then, in a case where the actual value continues to be smaller than the predicted value by the threshold value or more for the determination period consecutively after the candidate for the change point was detected, the change point determination unit 5 can determine the candidate for the change point as the change point.

According to the present invention, when the change point determination unit 5 determines the change point, the data correction unit 6 calculates the average value of the differences between the actual values and the predicted values in the determination period starting from the change point. Then, the data correction unit 6 corrects the time series data by adding the average value of these differences to the actual value of each day within the correction target period before the change point. As described with reference to FIGS. 5 and 6, in the time series data after the correction, the trend of the actual values before the change point and the trend of the actual values at the change point and afterward become comparable to each other. That is, a change in the trend of the actual value has been resolved. More specifically, the trend of the actual values before the change point matches the trend of the actual values at the change point and afterward. The learning model generation unit 3 regenerates the learning model using such time series data as learning data. Therefore, the prediction unit 4 can calculate the predicted value of the number of store visitors at the change point and afterward with high accuracy using this learning model. As described above, according to the present invention, it is possible to prevent a decrease in prediction accuracy in a case where the trend of the actual value of the prediction target has changed.

Next, modifications of the above exemplary embodiments will be described.

The change point determination unit 5 may determine the change point without using the predicted value. In this case, the prediction unit 4 does not have to send the predicted value to the change point determination unit 5. Also in the following description, explanation will be given for both of a case where the actual value becomes a larger value than those until the change point at the change point and later and a case where the actual value becomes a smaller value than those until the change point at the change point and later.

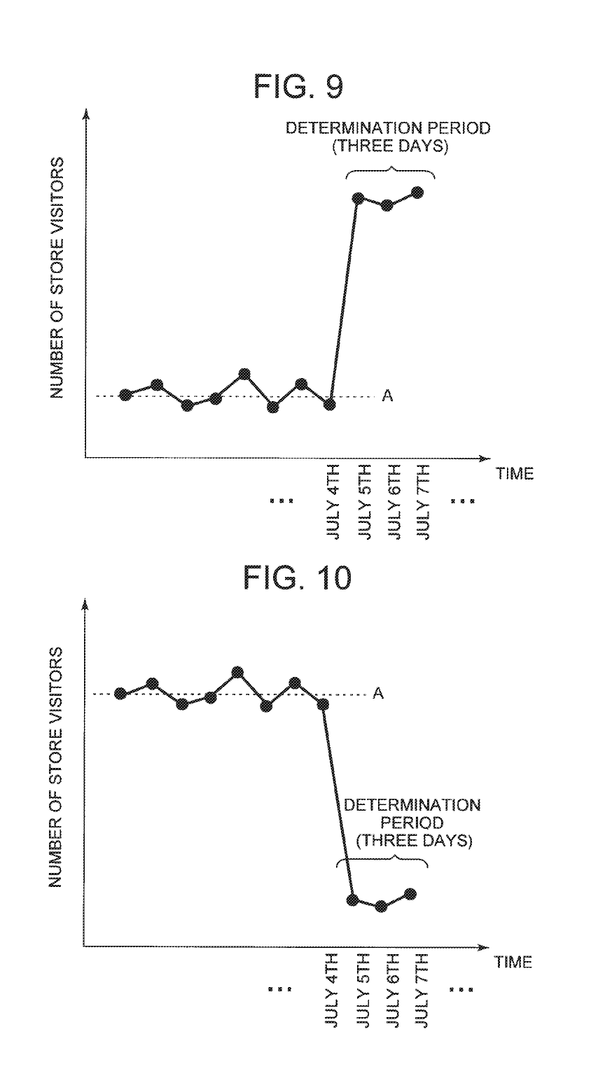

First, a case where the actual value becomes a larger value than those until the change point at the change point and later will be described with reference to FIG. 9. When a new actual value is input, the change point determination unit 5 calculates an average value of the actual values equivalent to a past certain time period from a point in time corresponding to an actual value immediately before this new actual value. For example, it is supposed that the actual value of July 5th is newly input. The change point determination unit 5 calculates an average value of the actual values equivalent to the past certain time period from a day corresponding to an actual value immediately before the above actual value (that is, July 4th). It is assumed that this average value of the actual values is A (refer to FIG. 9). In a case where the newly input actual value of July 5th is larger than the average value A by a threshold value or more and actual values subsequent to the newly input actual value of July 5th continue to be larger than the average value A by the threshold value or more for the determination period consecutively, the change point determination unit 5 sets a point in time corresponding to a first actual value larger than the average value A by the threshold value or more (in this example, July 5th) as the change point. The example illustrated in FIG. 9 assumes that the determination period is three days and both of the actual value of July 6th and the actual value of July 7th following the actual value of July 5th are larger than the average value A by the threshold value or more. Then, the change point determination unit 5 determines July 5th as the change point.

That is, on the condition that the newly input actual value is larger than the average value A of the actual values equivalent to the past certain time period from the point in time corresponding to the actual value immediately before this new actual value by the threshold value or more, the change point determination unit 5 sets a point in time corresponding to this newly input actual value as a candidate for the change point. Then, in a case where the subsequent actual values continue to be larger than the average value A by the threshold value or more for the determination period consecutively, the change point determination unit 5 determines this candidate for the change point as the change point. Meanwhile, in a case where the subsequent actual values do not continue to be larger than the average value A by the threshold value or more for the determination period consecutively, the change point determination unit 5 cancels the detected candidate for the change point from the candidate. Then, the change point determination unit 5 waits until the change point determination unit 5 detects a candidate for the change point again.

Next, a case where the actual value becomes a smaller value than those until the change point at the change point and later will be described with reference to FIG. 10. As in the case described with reference to FIG. 9, when a new actual value is input, the change point determination unit 5 calculates an average value of the actual values equivalent to a past certain time period from a point in time corresponding to an actual value immediately before this new actual value. For example, it is supposed that the actual value of July 5th is newly input. The change point determination unit 5 calculates an average value of the actual values equivalent to the past certain time period from a day corresponding to an actual value immediately before the above actual value (that is, July 4th). It is assumed that this average value of the actual values is A (refer to FIG. 10). In a case where the newly input actual value of July 5th is smaller than the average value A by a threshold value or more and actual values subsequent to the newly input actual value of July 5th continue to be smaller than the average value A by the threshold value or more for the determination period consecutively, the change point determination unit 5 sets a point in time corresponding to a first actual value smaller than the average value A by the threshold value or more (in this example, July 5th) as the change point. The example illustrated in FIG. 10 assumes that the determination period is three days and both of the actual value of July 6th and the actual value of July 7th following the actual value of July 5th are smaller than the average value A by the threshold value or more. Then, the change point determination unit 5 determines July 5th as the change point.

That is, on the condition that the newly input actual value is smaller than the average value A of the actual values equivalent to the past certain time period from the point in time corresponding to the actual value immediately before this new actual value by the threshold value or more, the change point determination unit 5 sets a point in time corresponding to this newly input actual value as a candidate for the change point. Then, in a case where the subsequent actual values continue to be smaller than the average value A by the threshold value or more for the determination period consecutively, the change point determination unit 5 determines this candidate for the change point as the change point. Meanwhile, in a case where the subsequent actual values do not continue to be smaller than the average value A by the threshold value or more for the determination period consecutively, the change point determination unit 5 cancels the detected candidate for the change point from the candidate. Then, the change point determination unit 5 waits until the change point determination unit 5 detects a candidate for the change point again.

Also in this modification, as in the above exemplary embodiments, it is possible to prevent a decrease in prediction accuracy in a case where the trend of the actual value of the prediction target has changed. Furthermore, in this modification, since the change point determination unit 5 can determine the change point without using the predicted value, the prediction unit 4 does not need to send the predicted value to the change point determination unit 5.

In the above exemplary embodiments and the modifications thereof, a case where the number of store visitors per day in a convenience store is treated as a prediction target has been described as an example, but the prediction target may be, for example, the number of attendance in various facilities such as movie theaters and theme parks.

In addition, the prediction target is not limited to the number of people such as the number of store visitors and the number of attendance but may be another matter such as the number of sales.

In the above exemplary embodiments and the modifications thereof, a case where “one day” is treated as a unit of time has been described as an example, but the unit of time may be other than “one day”.

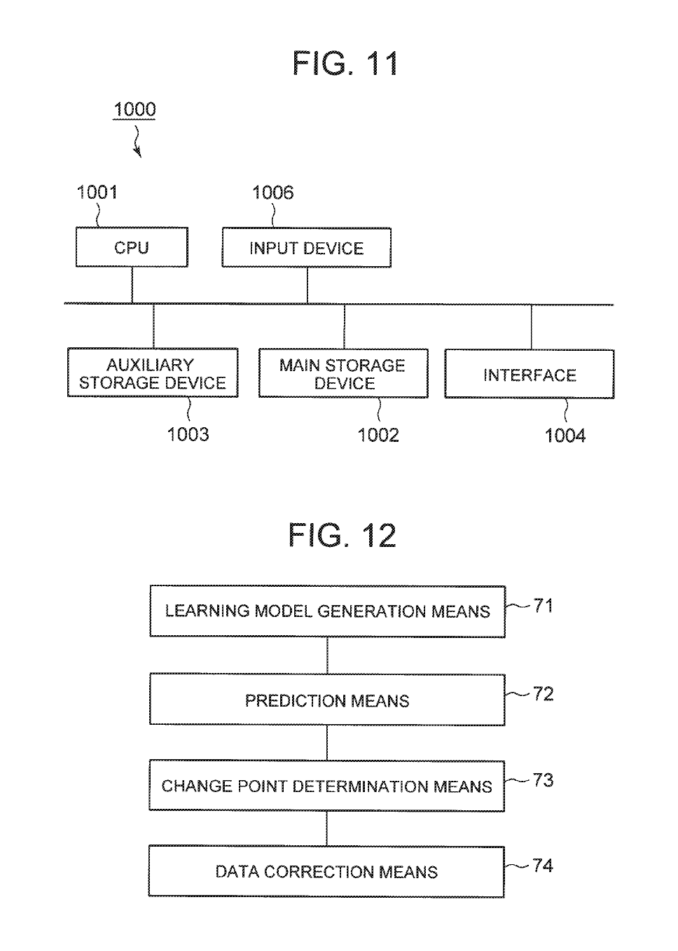

FIG. 11 is an overview block diagram illustrating a configuration example of a computer according to an exemplary embodiment of the present invention. The computer 1000 includes a CPU 1001, a main storage device 1002, an auxiliary storage device 1003, an interface 1004, and an input device 1006. The input device 1006 is an input interface for inputting the actual value and the value of each explanatory variable.

The learning model generation system 1 of the present invention is implemented in the computer 1000. The operation of the learning model generation system 1 is stored in the auxiliary storage device 1003 in the form of a program. The CPU 1001 retrieves the program from the auxiliary storage device 1003 to develop in the main storage device 1002 and executes the above processing in line with this program.

The auxiliary storage device 1003 is an example of a non-transitory tangible medium. Other examples of non-transitory tangible media include magnetic disks, magneto-optical disks, CD-ROMs, DVD-ROMs, and semiconductor memories connected via the interface 1004. In addition, when this program is delivered to the computer 1000 through a communication line, the computer 1000 that has accepted the delivery may develop the program in the main storage device 1002 and execute the above processing.

Meanwhile, the program may be for realizing a part of the above-described processing. Additionally, the program may be a differential program that realizes the above-described processing in combination with another program already stored in the auxiliary storage device 1003.

Next, the outline of the present invention will be described. FIG. 12 is a block diagram illustrating the outline of the learning model generation system of the present invention. The learning model generation system of the present invention includes a learning model generation means 71, a prediction means 72, a change point determination means 73, and a data correction means 74.

The learning model generation means 71 (for example, the learning model generation unit 3) generates a learning model for calculating a predicted value of a prediction target using, as learning data, time series data in which a value of each explanatory variable used in prediction of the prediction target is associated with an actual value of the prediction target.

The prediction means 72 (for example, the prediction unit 4) calculates the predicted value of the prediction target using the learning model once the value of each explanatory variable is given.

The change point determination means 73 (for example, the change point determination unit 5) determines a change point which is a point in time when a trend of the actual value of the prediction target changed.

The data correction means 74 (for example, the data correction unit 6) corrects the time series data by adding a difference between the actual value and the predicted value of the prediction target at the change point and afterward to the actual value before the change point in the time series data when the change point is determined.

The learning model generation means 71 regenerates the learning model using the time series data after the correction as the learning data once the time series data is corrected.

With such a configuration, it is possible to prevent a decrease in prediction accuracy in a case where the trend of the actual value of the prediction target has changed.

In addition, in a case where the actual value continues to be larger than the predicted value by a threshold value or more for a predetermined period (for example, the determination period) consecutively, the change point determination means 73 may determine a first point in time when the actual value became larger than the predicted value by the threshold value or more as the change point, or in a case where the actual value continues to be smaller than the predicted value by the threshold value or more for a predetermined period consecutively, the change point determination means 73 may determine a first point in time when the actual value became smaller than the predicted value by the threshold value or more as the change point.

In addition, when a new actual value is given, the change point determination means 73 may calculate an average value of the actual values equivalent to a past certain time period from a point in time corresponding to an actual value immediately before the new actual value and, in a case where the new actual value is larger than the average value by a threshold value or more and actual values subsequent to the new actual value continue to be larger than the average value by the threshold value or more for a predetermined period (for example, the determination period) consecutively, or a case where the new actual value is smaller than the average value by the threshold value or more and actual values subsequent to the new actual value continue to be smaller than the average value by the threshold value or more for a predetermined period consecutively, may determine a point in time corresponding to the new actual value as the change point.

In addition, the data correction means 74 may calculate an average value of differences between the measured values and the predicted values in a period from the change point to a point in time when the change point was determined and add the average value of the differences to the actual value before the change point in the time series data.

In addition, the data correction means 74 may calculate an average value of differences between the measured values and the predicted values in a period from the change point to a point in time when the change point was determined and add the average value of the differences to each actual value equivalent to a second predetermined period (for example, the correction target period) before the change point in the time series data, and the learning model generation means 71 may regenerate the learning model using data out of the time series data for an earliest point in time and afterward within the second predetermined period.

### INDUSTRIAL APPLICABILITY

The present invention is suitably applied to a learning model generation system configured to generate a learning model.

### REFERENCE SIGNS LIST

1 Learning model generation system
2 Data storage unit
3 Learning model generation unit
4 Prediction unit
5 Change point determination unit
6 Data correction unit

1. A learning model generation system comprising:
a learning model generation unit, implemented by a processor, that generates a learning model for calculating a predicted value of a prediction target using, as learning data, time series data in which a value of each explanatory variable used in prediction of the prediction target is associated with an actual value of the prediction target;
a prediction unit, implemented by the processor, that calculates the predicted value of the prediction target using the learning model once the value of each explanatory variable is given;
a change point determination unit, implemented by the processor, that determines a change point which is a point in time when a trend of the actual value of the prediction target changed; and
a data correction unit, implemented by the processor, that corrects the time series data by adding a difference between the actual value and the predicted value of the prediction target at the change point and afterward to the actual value before the change point in the time series data when the change point is determined, wherein
the learning model generation unit regenerates the learning model using the time series data after the correction as the learning data once the time series data is corrected.

2. The learning model generation system according to claim 1, wherein
in a case where the actual value continues to be larger than the predicted value by a threshold value or more for a predetermined period consecutively, the change point determination unit determines a first point in time when the actual value became larger than the predicted value by the threshold value or more as the change point, or in a case where the actual value continues to be smaller than the predicted value by the threshold value or more for a predetermined period consecutively, the change point determination unit determines a first point in time when the actual value became smaller than the predicted value by the threshold value or more as the change point.

3. The learning model generation system according to claim 1, wherein
when a new actual value is given, the change point determination unit calculates an average value of the actual values equivalent to a past certain time period from a point in time corresponding to an actual value immediately before the new actual value and, in a case where the new actual value is larger than the average value by a threshold value or more and actual values subsequent to the new actual value continue to be larger than the average value by the threshold value or more for a predetermined period consecutively, or a case where the new actual value is smaller than the average value by the threshold value or more and actual values subsequent to the new actual value continue to be smaller than the average value by the threshold value or more for a predetermined period consecutively, determines a point in time corresponding to the new actual value as the change point.

4. The learning model generation system according to claim 2, wherein
the data correction unit calculates an average value of differences between the measured values and the predicted values in a period from the change point to a point in time when the change point was determined and adds the average value of the differences to the actual value before the change point in the time series data.

5. The learning model generation system according to claim 2, wherein
the data correction unit calculates an average value of differences between the measured values and the predicted values in a period from the change point to a point in time when the change point was determined and adds the average value of the differences to each actual value equivalent to a second predetermined period before the change point in the time series data, and
the learning model generation unit regenerates the learning model using data out of the time series data for an earliest point in time and afterward within the second predetermined period.

6. A learning model generation method configured to:
generate a learning model for calculating a predicted value of a prediction target using, as learning data, time series data in which a value of each explanatory variable used in prediction of the prediction target is associated with an actual value of the prediction target;
calculate the predicted value of the prediction target using the learning model once the value of each explanatory variable is given;
determine a change point which is a point in time when a trend of the actual value of the prediction target changed;
correct the time series data by adding a difference between the actual value and the predicted value of the prediction target at the change point and afterward to the actual value before the change point in the time series data when the change point is determined; and
regenerate the learning model using the time series data after the correction as the learning data in a case where the time series data is corrected.

7. A non-transitory computer-readable recording medium in which a learning model generation program is recorded, the learning model generation program causing a computer to execute:
learning model generation processing of generating a learning model for calculating a predicted value of a prediction target using, as learning data, time series data in which a value of each explanatory variable used in prediction of the prediction target is associated with an actual value of the prediction target;
prediction processing of calculating the predicted value of the prediction target using the learning model once the value of each explanatory variable is given;
change point determination processing of determining a change point which is a point in time when a trend of the actual value of the prediction target changed;
data correction processing of correcting the time series data by adding a difference between the actual value and the predicted value of the prediction target at the change point and afterward to the actual value before the change point in the time series data when the change point is determined; and
processing of regenerating the learning model using the time series data after the correction as the learning data in a case where the time series data is corrected.
